(19) United States
(12) Patent Application Publication
(10) Pub. No.: US 2025/0102098 A1
(43) Pub. Date: Mar. 27, 2025

(54) PIPE REPAIR STENT WITH FRICTION ELEMENTS

(71) Applicant: Mueller International, LLC, Atlanta, GA (US)

(72) Inventor: Sean Michael Allen, Chattanooga, TN (US)

(21) Appl. No.: 18/373,920

(22) Filed: Sep. 27, 2023

(51) Int. Cl. F16L 55/163

(52) U.S. Cl. CPC F16L 55/163

(57) ABSTRACT

A pipe repair stent includes a gasket defining a first gasket end, a second gasket end opposite the first gasket end, an outer gasket surface, and an inner gasket surface, the inner gasket surface defining a main passage, a stent axis extending centrally through the main passage, the outer gasket surface at least partially defining an outer stent surface of the pipe repair stent; a first pipe engagement strip coupled to and extending circumferentially along the outer stent surface proximate to the first gasket end; and a second pipe engagement strip coupled to and extending circumferentially along the outer stent surface proximate to the second gasket end; wherein each of the first and second pipe engagement strips extend radially outward beyond the outer stent surface and are configured to engage an inner wall of a pipe to improve a grip of the pipe repair stent on the inner wall.

### TECHNICAL FIELD

This disclosure relates to the field of pipe repair. More specifically, this disclosure relates to pipe repair stents comprising pipe-engaging friction elements.

### BACKGROUND

Piping systems, including municipal water systems, can develop breaks in pipe walls that can cause leaking. Example of breaks in a pipe wall can include radial cracks, axial cracks, point cracks, etc. Repairing a break in a pipe wall often requires the piping system to be shut off, which can be inconvenient for customers and costly for providers. Further, repairs can necessitate grandiose construction, including the digging up of streets, sidewalks, and the like, which can be costly and time-consuming.

Repair stents can be inserted into a damaged pipe and sealed against an inner surface of the pipe wall at the site of the damage to prevent leaking. However, fluid flowing through the pipe can creep in between the stent and pipe to weaken the seal therebetween or can even dislodge the stent from the desired location, re-exposing the crack or causing other damage.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is a pipe repair stent comprising a gasket defining a first gasket end, a second gasket end opposite the first gasket end, an outer gasket surface, and an inner gasket surface opposite the outer gasket surface, the inner gasket surface defining a main passage, a stent axis extending centrally through the main passage, the outer gasket surface at least partially defining an outer stent surface of the pipe repair stent; a first pipe engagement strip coupled to and extending circumferentially along the outer stent surface proximate to the first gasket end; and a second pipe engagement strip coupled to and extending circumferentially along the outer stent surface proximate to the second gasket end; wherein each of the first and second pipe engagement strips extend radially outward beyond the outer stent surface and are configured to engage an inner wall of a pipe to improve a grip of the pipe repair stent on the inner wall.

Also disclosed is a pipe repair stent comprising a gasket defining a first gasket end, a second gasket end opposite the first gasket end, an outer gasket surface, and an inner gasket surface opposite the outer gasket surface, the inner gasket surface defining a main passage, a stent axis extending centrally through the main passage, the outer gasket surface at least partially defining an outer stent surface of the pipe repair stent; and a first plurality of grippers coupled to and extending radially outward from the outer stent surface proximate to the first gasket end; and a second plurality of grippers coupled to and extending radially outward from the outer stent surface proximate to the second gasket end; wherein each of the first plurality of grippers and the second plurality of grippers are configured to engage an inner wall of a pipe to improve a grip of the pipe repair stent on the inner wall.

Also disclosed is a method of repairing a pipeline comprising providing a pipe repair stent, the pipe repair stent comprising a gasket, a first friction element, and a second friction element, the gasket defining a first gasket end, a second gasket end, an outer gasket surface, and an inner gasket surface, the outer gasket surface at least partially defining an outer stent surface of the pipe repair stent, the first friction element coupled to the outer stent surface proximate to the first gasket end and the second friction element coupled to the outer stent surface proximate to the second gasket end; transporting the pipe repair stent through the pipeline in a collapsed configuration to a location of damage; expanding the pipe repair stent to an expanded configuration to seal the outer gasket surface with an inner wall of the pipeline; and pressing the first friction element and the second friction element between the outer stent surface and the inner wall of the pipeline to increase friction between the pipe repair stent and the inner wall.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a perspective view of a pipe repair stent in an unfolded configuration, in accordance with one aspect of the present disclosure.

FIG. 2 is an end view of the pipe repair stent of FIG. 1.

FIG. 3 is a top view of a gasket of the pipe repair stent of FIG. 1.

FIG. 4 is a perspective view of an epoxy ring of the pipe repair stent of FIG. 1.

FIG. 5 is a perspective view of a channel cover of the pipe repair stent of FIG. 1.

FIG. 6 is a perspective view of a friction element of the pipe repair stent of FIG. 1.

FIG. 7 is a top view of the pipe repair stent of FIG. 1.

FIG. 8 is a cross-sectional view of the pipe repair stent of FIG. 1, taken along line 8-8 in FIG. 7.

FIG. 9 is a top perspective view of the pipe repair stent of FIG. 1 in a folded configuration.

FIG. 10 is a bottom perspective view of the pipe repair stent of FIG. 1 in the folded configuration.

FIG. 11 is a perspective view of the pipe repair stent in the unfolded configuration, in accordance with another aspect of the present disclosure.

FIG. 12 is an end view of the pipe repair stent of FIG. 11.

FIG. 13 is a perspective view of the channel cover of the pipe repair stent of FIG. 11.

FIG. 14 is a perspective view of a stud of the pipe repair stent of FIG. 11.

FIG. 15 is a perspective view of one of the friction elements of the pipe repair stent of FIG. 11.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutations of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a repair stent for repairing a damaged pipeline and associated methods, systems, devices, and various apparatus. Example aspects of the repair stent can comprise one or more friction elements configured to engage and grip an inner wall of the pipeline. It would be understood by one of skill in the art that the repair stent is described in but a few exemplary embodiments among many. No particular terminology or description should be considered limiting on the disclosure or the scope of any claims issuing therefrom.

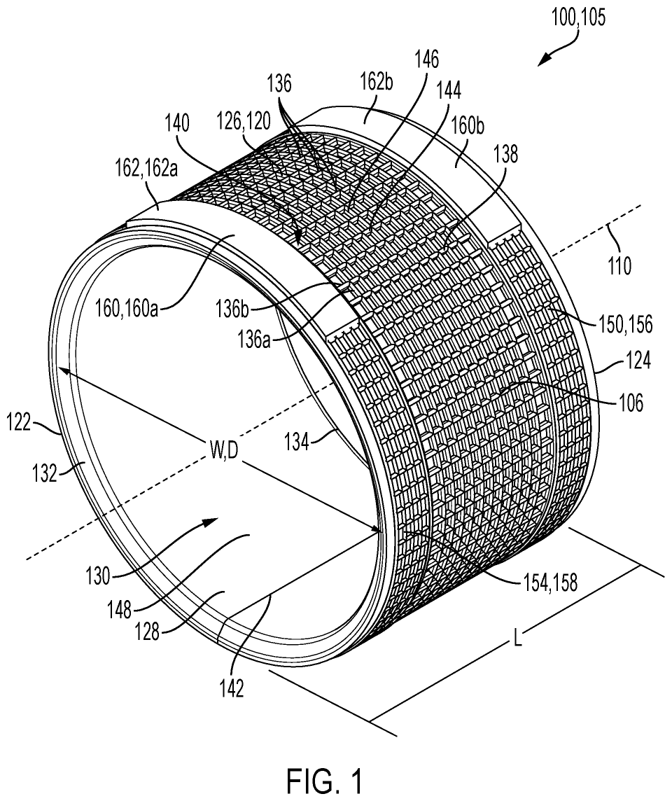

FIG. 1 illustrates a perspective view of a pipe repair device 100 according to an example aspect of the present disclosure. According to example aspects, the pipe repair device 100 can be configured to be expanded within a pipeline where a crack or other damage is present. The pipe repair device 100 can seal with an inner wall of the pipeline to prevent leaking at the site of damage. For example, the pipeline can be municipal water pipeline system, a sewage pipeline system, a gas pipeline system, or any other suitable pipeline system. As described in further detail below, the pipe repair device 100 can be configurable in a collapsed (e.g., folded) configuration for transport through the pipeline to the location of damage and in an expanded configuration (shown) wherein the pipe repair device 100 can seal with the inner wall of the pipeline to repair the damage.

The pipe repair device 100 can be formed as a repair stent 105, for example. Repairing pipe damage with a stent can reduce costs and construction requirements. Stents can be flexible and/or foldable and/or collapsible to decrease the stent's size for transport through the piping system to the location of the damage. However, the flexibility, foldability, and/or collapsibility of the stent can reduce the structural integrity of the stent, and stents commonly become displaced or are swept away under high flow conditions. The repair stent 105 of the present disclosure can be reinforced to improve the structural integrity of the repair stent 105 while still allowing for collapsibility and can also improve comprise friction elements to increase the friction between the repair stent 105 and the inner wall of the pipeline to retain the repair stent 105 in position at the site of damage.

According to the present aspect, the repair stent 105 can comprise a gasket 120 and a structural chassis 150 for reinforcing the gasket 120 and biasing the gasket 120 to the expanded configuration. The gasket 120 can define a first gasket end 122 and a second gasket end 124. A length L of the repair stent 105 can be defined between the first gasket end 122 and the second gasket end 124. The gasket 120 can be substantially cylindrical in the expanded configuration and can be formed as a continuous, tubular sleeve structure, as shown. The repair stent 105 can define a width W/diameter D, which can be maximized in the expanded configuration of the repair stent 105 and reduced in the collapsed configuration of the repair stent 105. In various example aspects, the gasket 120 can initially be manufactured as a substantially flat or planar piece of material that can be wrapped into the substantially cylindrical shape and sealed at a gasket seam 142 to retain the repair stent 105 in the cylindrical shape. In example aspects, the width W/diameter D of the repair stent 105 can be substantially consistent from the first gasket end 122 to the second gasket end 124. However, in other aspects, the width W/diameter D of the repair stent 105 at an axial center 144 thereof may be reduced in comparison to the width W/diameter D of the repair stent 105 at the first and second gasket ends 122, 124. That is, the width W/diameter D of the repair stent 105 can taper radially inwards from the first and second gasket ends 122,124 towards the axial center 144 of the gasket 120.

The gasket 120 can further define an outer gasket surface 126 and an inner gasket surface 128. The inner gasket surface 128 of the gasket 120 can define a main passage 130 therethrough. Fluid in the pipeline can be configured to flow through the main passage 130 of the gasket 120 in the expanded configuration. The inner gasket surface 128 can be substantially smooth in example aspects, as shown. A stent axis 110 of the repair stent 105 can extend centrally through the main passage 130 from the first gasket end 122 to the second gasket end 124. In example aspects, the length L of the gasket 120 can taper generally from the outer gasket surface 126 to the inner gasket surface 128 at each of the first gasket end 122 and the second gasket end 124 to define a first tapered end portion 132 at the first gasket end 122 and a second tapered end portion 134 at the second gasket end 124. The first tapered end portion 132 and the second tapered end portion 134 can help guide fluid in the pipeline through the main passage 130 and reduce the likelihood of fluid creeping in between the gasket 120 and the inner wall of the pipeline, which can displace the repair stent 105, and in some cases can drag the repair stent 105 downstream. In some example aspects, a plurality of the repair stents 105 can be joined together in series in the axial direction, relative to the stent axis 110, to form a lengthened repair stent 105 for repairing larger cracks or damage in the pipeline.

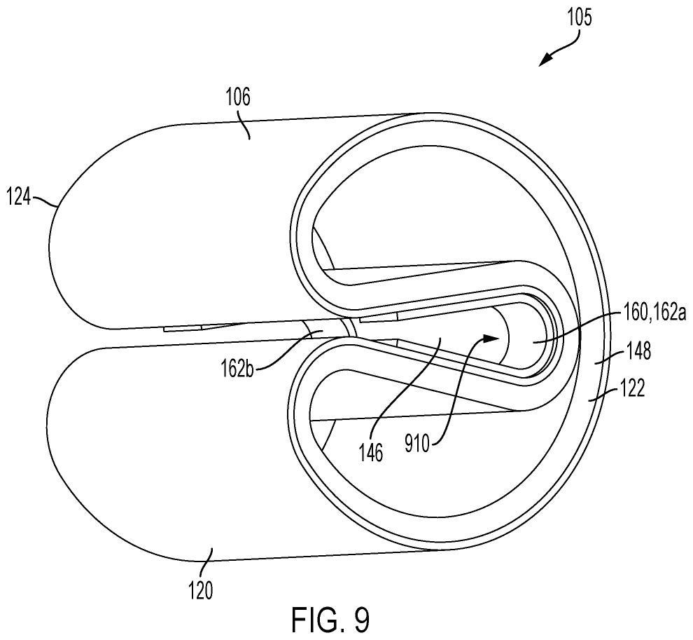

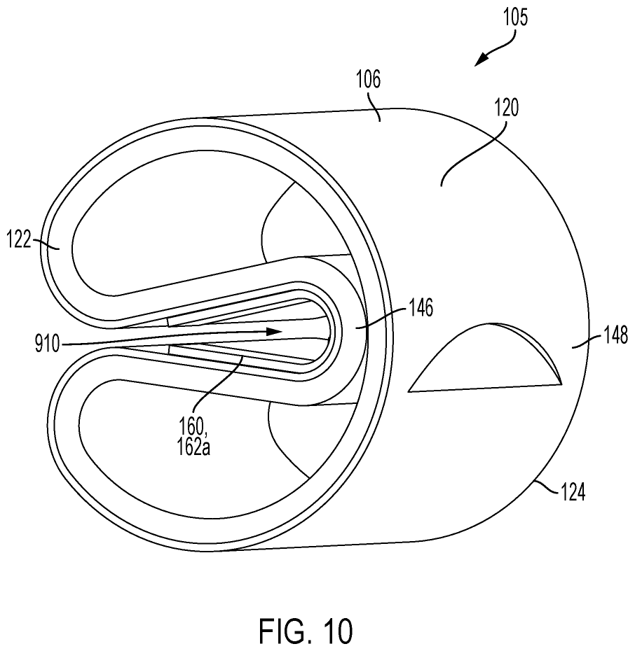

Example aspects of the gasket 120 can comprise a flexible, resilient, and/or compressible material. In the present aspect, the gasket 120 can comprise a synthetic rubber material, such as, for example, EPDM (ethylene propylene diene monomer) rubber. In other aspects, the gasket 120 can be formed from another rubber material such as neoprene, natural rubber, foam, epoxy, silicone, a resin-soaked cloth, a rubber glue, or any other suitably flexible rubber or non-rubber material or combination of materials. In some aspects, the outer gasket surface 126 can be substantially smooth, as shown in the embodiment of FIGS. 9 and 10; however, in the present aspect, the outer gasket surface 126 or portions thereof can be textured. The textured outer gasket surface 126 can improve the grip of the outer gasket surface 126 on the inner wall of the pipeline, as described in further detail below.

For example, the outer gasket surface 126 can define a plurality of raised ridges 136 extending radially outward relative to the stent axis 110 and a plurality of recessed dimples 140 formed between and disposed radially inward of the raised ridges 136, relative to the stent axis 110. In the present aspect, the raised ridges 136 can be arranged in a crisscross or waffle pattern. For example, the raised ridges 136 can comprise a plurality of generally circumferential ridges 136a and a plurality of generally axial ridges 136b arranged perpendicular to and intersecting the circumferential ridges 136a. In other aspects, the raised ridges 136 can be arranged to define any other suitable pattern. In some aspects, each of the raised ridges 136 can define a substantially square or rectangular cross-section having substantially angular edges. However, in other aspects, such as the present aspect, each of the raised ridges 136 can be curved or chamfered at a radially outer end 138 thereof, relative to the stent axis 110. In some aspects, the curved radially outer ends 138 of the raised ridges 136 can provide an improved grip with the inner wall of the pipeline, as compared to ridges 136 defining a substantially square or rectangular profile, as the curved radially outer ends 138 may more easily conform to variations on the inner wall of the pipeline.

The recessed dimples 140 can be defined between adjacent pairs of the circumferential ridges 136a and the axial ridges 136b. Each of the recessed dimples 140 can be substantially square shaped in the present aspect, though in other aspects, the recessed dimples 140 can define any other suitable shape, including but not limited to rectangular, circular, triangular, or the like. The recessed dimples 140 can be arranged in a plurality of rows and a plurality of columns. The columns of the recessed dimples 140 and the circumferential ridges 136a can extend circumferentially about the gasket 120, relative to the stent axis 110. The rows of the recessed dimples 140 and the axial ridges 136b can extend axially along the gasket 120, relative to the stent axis 110. According to example aspects, biasing the raised ridges 136 against the inner wall of the pipeline in the expanded configuration can create a suction force within the recessed dimples 140, which can aid in retaining the repair stent 105 against the inner wall. In other aspects, the outer gasket surface 126 may not comprise the raised ridges 136 as described, but can be otherwise textured, uneven, bumpy, rough, or non-smooth. For example, in other aspects, the outer gasket surface 126 of the gasket 120 can comprise an abrasive material, or can comprise projections, spikes, or grippers, or the like extending therefrom for improving the grip of the gasket 120 on the inner wall of the pipeline. In other aspects, the outer gasket surface 126 can be substantially smooth.

The outer gasket surface 126 of the gasket 120 can further define one or more

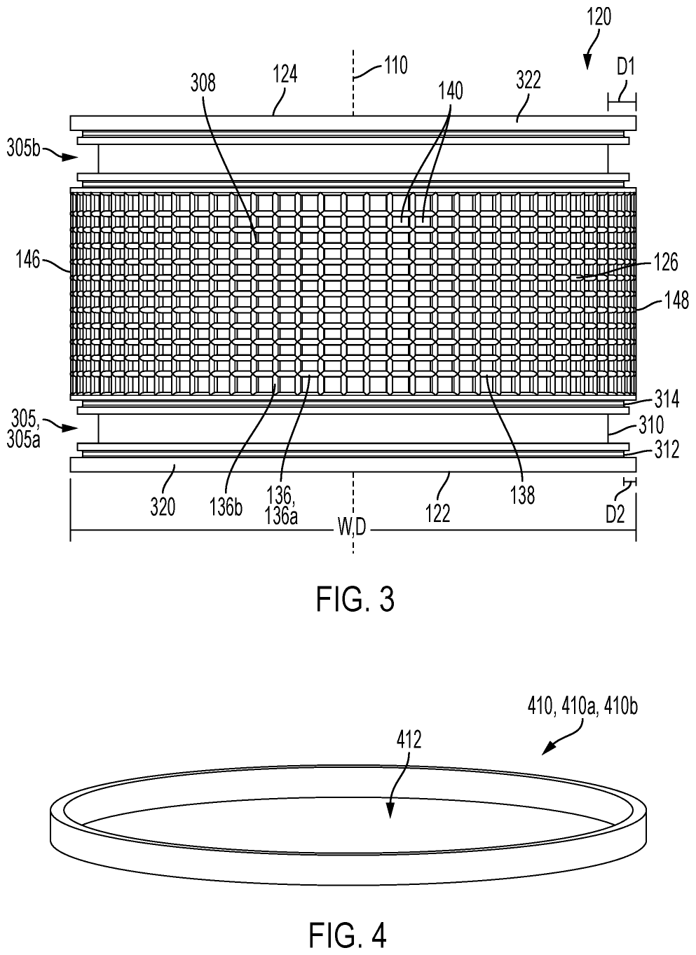

circumferential grooves 305 (shown in FIG. 3). For example, the circumferential grooves 305 can comprise a first circumferential groove 305a (shown in FIG. 3) formed proximate to the first gasket end 122 and a second circumferential groove 305b (shown in FIG. 3) formed proximate to the second gasket end 124. The structural chassis 150 can comprise one or more annular reinforcement rings 410 (shown in FIG. 4). For example, the reinforcement rings 410 can comprise a first reinforcement ring 410a (shown in FIG. 4) disposed within the first circumferential groove 305a and a second reinforcement ring 410b (shown in FIG. 4) disposed within the second circumferential groove 305b. Other aspects of the repair stent 105 can comprise more or fewer of the circumferential grooves 305 and the annular reinforcement rings 410 disposed therein. Each of the annular reinforcement rings 410 can comprise a reinforcement material, such as, for example and without limitation, epoxy, spring rubber, hard rubber, or the like.

In some aspects, such as aspects wherein the first and annular reinforcement rings 410 comprise a spring rubber or hard rubber reinforcement material, the annular reinforcement rings 410 can be slipped over the first and/or second gasket ends 122,124 and into the corresponding first or second circumferential grooves 305 respectively. In aspects wherein the annular reinforcement rings 410 comprise an epoxy reinforcement material, the first and second reinforcement rings 410a,b can be formed by applying an uncured epoxy material within the first and second circumferential grooves 305a,b. The epoxy reinforcement material can be substantially flexible when initially applied within the first and second circumferential grooves 305a,b, which can allow the repair stent 105 to fold, bend, compress, and/or collapse to the collapsed configuration. The epoxy reinforcement material can be cured once the repair stent 105 is positioned at the desired location in the pipeline in the expanded configuration. As the epoxy reinforcement material cures, the first and second reinforcement rings 410a,b can become more rigid and can provide even, circumferential support to the repair stent 105 at the first gasket end 122 and the second gasket end 124. The epoxy reinforcement material can be configured to cure on its own over time or can be cured with UV (ultraviolet) radiation or any other suitable type of radiation or curing technique.

Further, in some aspects, the structural chassis 150 can comprise an annular first groove cover 154 and an annular second groove cover 156. Such annular reinforcement rings 410 and groove covers 154,156 are described in U.S. application Ser. No. 18/072,654, filed Nov. 30,2022, which is hereby specifically incorporated by reference herein in its entirety. The first groove cover 154 can extend circumferentially about the gasket 120, relative to the stent axis 110, and can cover and protect the first circumferential groove 305a and the first reinforcement ring 410a at the first gasket end 122. The second groove cover 156 can extend circumferentially about the gasket 120, relative to the stent axis 110, and can cover and protect the second circumferential groove 305b and the second reinforcement ring 410b at the second gasket end 124. In other aspects, the first and second reinforcement rings 410a,b and/or the first and second groove covers 154,156 can extend only partially about the circumference of the gasket 120. In some aspects, the structural chassis 150 can further comprise one or more axial reinforcement rods for further reinforcing the repair stent 105, as also disclosed in U.S. application Ser. No. 18/072,654.

In some aspects, an outer cover surface 158 of each of the first and second groove covers 154,156 can be substantially smooth, as shown in the embodiment of FIGS. 9 and 10; however, in the present aspect, the outer cover surface 158 or portions thereof can be textured. The textured outer cover surface 158, like the textured outer gasket surface 126, can improve the grip of the repair stent 105 on the inner wall of the pipeline. In the present aspect, the outer cover surface 158 of each of the first and second groove covers 154,156 can also define a plurality of the raised ridges 136 extending radially outward relative to the stent axis 110 and a plurality of the recessed dimples 140 formed between and disposed radially inward of the raised ridges 136, relative to the stent axis 110. Like the raised ridges 136 of the gasket 120, the raised ridges 136 of the first and second groove covers 154,156 can be arranged in a crisscross or waffle pattern, as shown. That is, the raised ridges 136 of the first and second groove covers 154,156 can comprise a plurality of the generally circumferential ridges 136a and a plurality of the generally axial ridges 136b arranged perpendicular to and intersecting the circumferential ridges 136a.

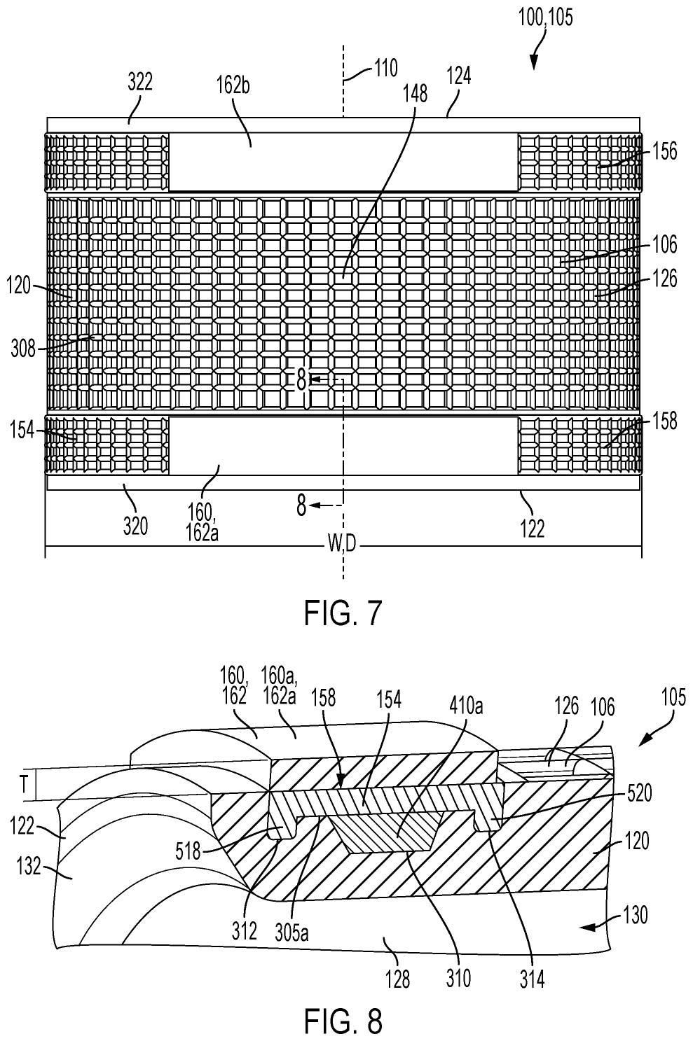

In some aspects, the raised ridges 136 and/or the recessed dimples 140 of the first and second groove covers 154,156 can be similar to the same in size and/or shape to the raised ridges 136 and the recessed dimples 140 of the gasket 120. In other aspects, the raised ridges 136 of the first and second groove covers 154,156 can be arranged to define any other suitable pattern. Additionally, in other aspects, the raised ridges 136 and/or the recessed dimples 140 of the first and second groove covers 154,156 can define any other suitable size and/or shape. Furthermore, in some example aspects, the outer cover surface 158 of each of the first and second groove covers 154,156 can be substantially flush with the outer gasket surface 126 of the gasket 120, while in other aspects, the outer cover surface 158 may not be substantially flush with the outer gasket surface 126. For example, in the present aspect, the outer cover surface 158 of each of the first and second groove covers 154,156 can extend slightly radially outward beyond the outer gasket surface 126, as best seen in FIG. 7. The outer gasket surface 126 of the gasket 120 and the outer cover surface 158 of each of the first and second groove covers 154,156 can together define an outer stent surface 106 of the repair stent 105.

The first and second groove covers 154,156 can comprise a resilient, flexible metal material, such as rubber, for example and without limitation. In some aspects, the rubber material of the first and second groove covers 154,156 can be EPDM rubber. In other aspects, the rubber material can be, for example and without limitation, NBR (nitrile butadiene rubber) or polyurethane. In other aspects, the first and second groove covers 154,156 can comprise any other suitable resilient, flexible rubber or non-rubber material or combination of materials. Optionally, the material of the first and second groove covers 154,156 can be an NSF certified material that can comply with various public health safety standards. For example, in some aspects, the material can be approved as safe for use in drinking-water applications. Other aspects of the repair stent 105 may not comprise the first and second groove covers 154,156, and the first and second reinforcement rings 410a,b can be exposed.

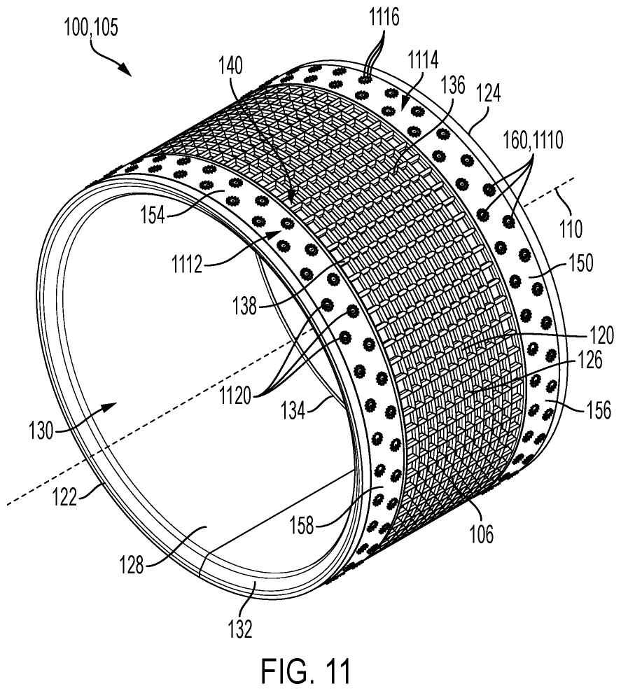

Example aspects of the repair stent 105 can further comprise one or more of the friction elements 160 applied to the outer stent surface 106 of the repair stent 105. The friction elements 160 can be configured to engage the inner wall of the pipeline in the expanded configuration to further improve the grip of the repair stent 105 on the inner wall of the pipeline. In the present aspect, the friction elements 160 can comprise a first friction element 160a disposed generally at or near the first gasket end 122 and a second friction element 160b disposed generally at or near the second gasket end 124. Example aspects of the friction elements 160 can be formed as pipe engagement strips 162. The first friction element 160a can be a first pipe engagement strip 162a, and the second friction element 160b can be a second pipe engagement strip 162b. In other aspects, the friction elements 160 can have an alternative design, such as the friction elements 160 illustrated in FIGS. 11-15. Each of the first and second pipe engagement strips 162a,b can be substantially arcuate in the present aspect and can extend partially about the circumference of the repair stent 105. In other aspects, however, either or both of the first and second pipe engagement strips 162a,b can extend entirely about the circumference of the repair stent 105. According to example aspects, the first pipe engagement strip 162a can be coupled to the first groove cover 154 at the first gasket end 122, and the second pipe engagement strip 162b can be coupled to the second groove cover 156 at the second gasket end 154. Moreover, in the present aspect, the first pipe engagement strip 162a and the second engagement strip 162b can be axially aligned at a first gasket side 146 of the gasket 120.

In other aspects, the pipe engagement strips 162 can be applied at any other suitable location on the outer stent surface 106 of the repair stent 105, such as to the outer gasket surface 126 of the gasket 120. For example, in aspects of the repair stent 105 not comprising the groove covers 154,156, the first and second pipe engagement strips 162a,b can be applied to the outer gasket surface 126 adjacent to the first and second gasket ends 122,124, respectively. In other aspects, the pipe engagement strips 162 can extend axially along the repair stent 105. Moreover, other aspects of the repair stent 105 can comprise more or fewer of the pipe engagement strips 162.

Each of the first and second pipe engagement strips 162a,b can be formed from, for example and without limitation, an epoxy material. In other aspects, the first and second pipe engagement strips 162a,b can comprise glue, putty, or any other suitable material. Similar to the first and second reinforcement rings 410a,b, the first and second pipe engagement strips 162a,b can be formed by applying an uncured epoxy material to the outer cover surface 158 of the first and second groove covers 154,156, respectively. The epoxy material can be substantially flexible when initially applied to the outer cover surface 158, which can allow the repair stent 105 to fold, bend, compress, and/or collapse to the collapsed configuration. Additionally, the flexible nature of the uncured epoxy material can allow the epoxy material to exude into the recessed dimples 140 of the first and second groove covers 154,156 in some aspects. Like the first and second reinforcement rings 410a,b, the epoxy material of the first and second pipe engagement strips 162a,b can be cured once the repair stent 105 is positioned at the desired location in the pipeline in the expanded configuration. As the epoxy material cures, the first and second pipe engagement strips 162a,b can become more rigid. The epoxy material can be configured to cure on its own over time or can be cured with UV (ultraviolet) radiation or any other suitable type of radiation or curing technique.

The repair stent 105 can be configurable in the expanded configuration and the collapsed configuration. In the collapsed configuration, the repair stent 105 can be folded, bent, compressed, collapsed, and/or otherwise reconfigured to reduce the width W and/or diameter D of the repair stent 105 as compared to the expanded configuration. The flexibility of the gasket 120, the first and second groove covers 154,156, and the uncured epoxy material of the reinforcement rings 410 and the pipe engagement strips 162 can facilitate arranging the repair stent 105 in the collapsed configuration. The reduced width W and/or diameter D of the repair stent 105 in the collapsed configuration can allow the repair stent 105 to be easily inserted into and transported through the pipeline to the location of damage.

A force (e.g., a pushing or pulling force) can be applied to the repair stent 105 to fold or otherwise configure the repair stent 105 in the collapsed configuration. In some aspects, the first gasket side 146 of the gasket 120 can be pushed radially inward, relative to the stent axis 110, towards an opposite second gasket side 148 of the gasket 120 to fold the repair stent 105 into a C-shape, as shown in FIG. 9. According to example aspects, the first and second pipe engagement strips 162a,b can be arranged at the first gasket side 146, such that the first and second pipe engagement strips 162a,b can be disposed within an interior fold 910 (shown in FIG. 9) of the C-shaped repair stent 105 in the collapsed configuration. The positioning of the first and second pipe engagement strips 162a,b within the interior fold 910 can prevent the uncured epoxy material (or the glue, putty, or other material) of the first and second pipe engagement strips 162a,b from catching on the inner wall of the pipeline as the repair stent 105 is transported through the pipeline. In other example aspects, the repair stent 105 can be collapsed in any suitable manner to reduce the width W and/or diameter D thereof for transportation through the pipeline.

When the force biasing the repair stent 105 to the collapsed configuration is removed, the resiliency of the gasket 120 and the resiliency of the first and second groove covers 154,156 can bias the repair stent 105 back to the expanded configuration. The first and second reinforcement rings 410a,b can reinforce the first and second gasket ends 122,124, respectively, to hold the outer gasket surface 126 and the outer cover surface 158 against the inner wall of the pipeline. Additionally, the first and second pipe engagement strips 162a,b can be pressed between the groove covers 154,156 and the inner wall of the pipeline to further increase the friction between the repair stent 105 and the inner wall, particularly at the first and second gasket ends 122,124. The repair stent 105 can thereby be held in place within the pipeline and can be less susceptible to slipping or dislodging from the desired location. In aspects wherein the first and second reinforcement rings 410a,b and/or the first and second pipe engagement strips 162a,b comprise a glue or epoxy material, the first and second reinforcement rings 410a,b and/or the first and second pipe engagement strips 162a,b can cure and stiffen once in the expanded configuration.

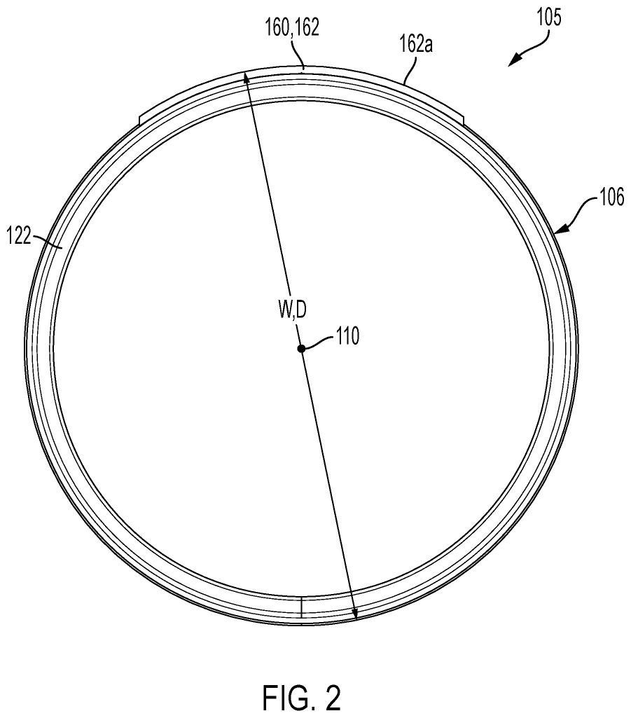

FIG. 2 illustrates an end view of the repair stent 105. As shown, the friction elements 160 (e.g., the pipe engagement strips 162) can extend radially outward from the outer stent surface 106 of the repair stent 105, such that the width W and/or diameter D of the repair stent 105 can be greater at the location of each pipe engagement strip 162, as shown. When the repair stent 105 is biased to the expanded configuration within the pipeline, the friction elements 160 can be pushed against the inner wall of the pipeline to increase the friction between the repair stent 105 and inner wall at the first and second gasket ends 122,124 (second gasket end 124 shown in FIG. 1).

FIG. 3 illustrates a perspective view of the gasket 120. The gasket 120 can define the first gasket end 122 and the second gasket end 124 opposite the first gasket end. The outer gasket surface 126 can at least partially define the outer stent surface 106 (shown in FIG. 1). The outer gasket surface 126 can define the first circumferential groove 305a formed adjacent to the first gasket end 122 and the second circumferential groove 305b formed adjacent to the second gasket end 124. The outer gasket surface 126 can further define the raised ridges 136 and the recessed dimples 140, which can define a textured portion 308 of the outer gasket surface 126. The textured portion 308 can be disposed axially between the first circumferential groove 305a and the second circumferential groove 305b, relative to the stent axis 110 (shown in FIG. 1).

According to example aspects, the gasket 120 can define a first sealing lip 320 extending radially outward at the first gasket end 122 and a second sealing lip 322 extending radially outward at the second gasket end 124, relative to the gasket axis 110. The first circumferential groove 305a can be defined axially between the first sealing lip 320 and the textured portion 308 of the gasket 120, relative to the stent axis 110. The second circumferential groove 305b can be defined axially between the second sealing lip 322 and the textured portion 308 of the gasket 120, relative to the stent axis 110. In example aspects, the width W/diameter D of the repair stent 105 (shown in FIG. 1) at each of the first sealing lip 320 and the second sealing lip 322 can be about equal to the width W/diameter D of the repair stent 105 at the textured portion 308.

Each of the first circumferential groove 305a and the second circumferential groove 305b can define a central reinforcement notch 310 extending circumferentially about the gasket 120. The central reinforcement notch 310 of the first circumferential groove 305a can be configured to receive the first reinforcement ring 410a (shown in FIG. 4), and the central reinforcement notch 310 of the second circumferential groove 305b can be configured to receive the second reinforcement ring 410b (shown in FIG. 4). Each of the central reinforcement notches 310 can extend radially into the gasket 120, relative to the stent axis 110, at a depth D1. In some aspects, a width of each central reinforcement notch 310 can taper radially inward to generally define a cross-sectional shape of an inverted isosceles trapezoid, as best seen in the cross-sectional view of FIG. 8.

Each of the first circumferential groove 305a and second circumferential groove 305b can further define an outer snap notch 312 and inner snap notch 314 extending circumferentially about the gasket 120. Each of the central reinforcement notches outer and inner snap notches 312,314 can extend radially into the gasket 120, relative to the stent axis 110, at a depth D₂. The depth D₂ of the outer and inner snap notches 312,314 can be less than the depth D₁ of the central reinforcement notch 310 in some aspects. In other aspects, the depth D₂ can be about equal to or greater than the depth D₁. In some aspects, the outer snap notch 312 and the inner snap notch 314 can be formed as dovetail notches, the cross-sectional shape of which can generally define an isosceles trapezoid, as further described in U.S. application Ser. No. 18/072,654. In other aspects, the outer and inner snap notches 312,314 may not be formed as dovetail notches.

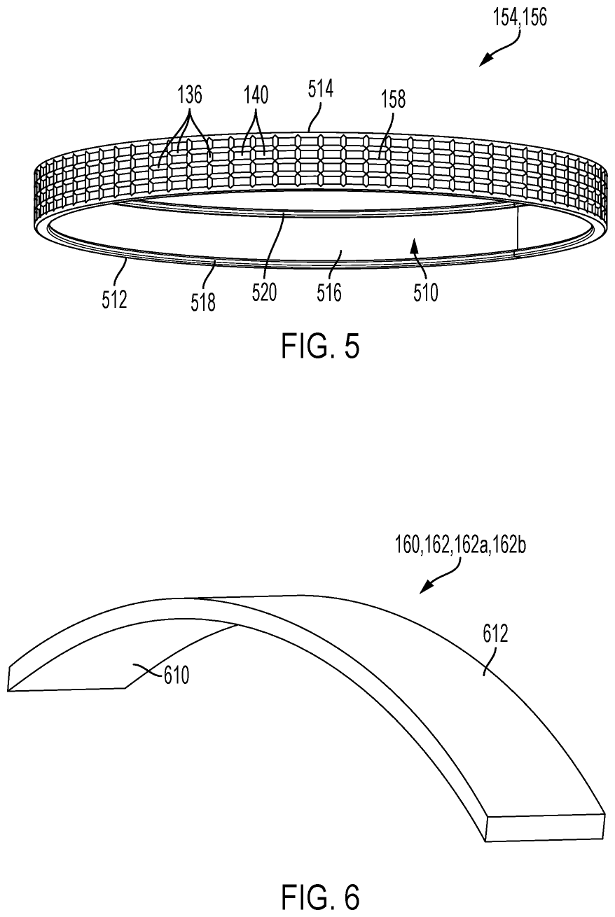

Each central reinforcement notch 310 can be disposed axially between the corresponding outer snap notch 312 and inner snap notch 314, relative to the stent axis 110. The outer snap notch 312 can be configured to receive an outer snap tab 518 (shown in FIG. 5) of the corresponding first or second groove cover 154,156 (shown in FIG. 1), and the inner snap notch 314 can be configured to receive an inner snap tab 520 (shown in FIG. 5) of the corresponding first or second groove cover 154,156. Snapping the outer snap tab 518 into the outer snap notch 312 and the inner snap tab 520 into the inner snap notch 314 can retain the first and second groove covers 154,156 in the corresponding first and second circumferential grooves 305a,b, respectively, of the gasket 120. In some aspects, the outer snap tab 518 and the inner snap tab 520 can define an isosceles trapezoid cross-sectional shape, which can allow for effective snapping of the outer and inner snap tabs 518,520 into the dovetail outer and inner snap notches 312,314. Other aspects of the outer and inner snap tabs 518,520 can define any other suitable cross-sectional shape. In some aspects, the first and second groove covers 154,156 can be further or alternatively be coupled to the gasket 120 by an adhesive or other suitable fastener to ensure that the first and second groove covers 154,156 are sufficiently secured to the gasket 120.

FIG. 4 illustrates a perspective view of one of the reinforcement rings 410 (e.g., the first reinforcement ring 410a or the second reinforcement ring 410b, which can be substantially the same). The reinforcement ring 410 can be substantially annular, as shown, and can define a ring opening 412 through a center thereof. In some aspects, a cross-sectional shape of the reinforcement ring 410 taken along line 4-4 can be that of an inverted isosceles trapezoid to substantially match the profile of the corresponding central reinforcement notch 310 (shown in FIG. 3) of the gasket 120 (shown in FIG. 1). As previously described, example aspects of the reinforcement ring 410 can be formed from a flexible, uncured epoxy or glue material which can harden in the shape shown once cured.

FIG. 5 illustrates a perspective view of one of the groove covers 154,156 (e.g., the first groove cover 154 or the second groove cover 156, which can be substantially the same). The groove cover 154,156 can be substantially annular, as shown, and can define a cover opening 510 through a center thereof. The groove cover 154,156 can define a first cover end 512, a second cover end 514 opposite the first cover end 512, the outer cover surface 158, and an inner cover surface 516 opposite the outer cover surface 158. As previously described, the outer cover surface 158 can be textured in some aspects (e.g., can comprise the raised ridges 136) but may be substantially smooth in other aspects. The groove cover 154,156 can define the outer snap tab 518 extending radially inward from the inner cover surface 516 at the first cover end 512 and the inner snap tab 520 extending radially inward from the inner cover surface 516 at the second cover end 514, relative to the stent axis 110 (shown in FIG. 1). Each of the outer snap tab 518 and the inner snap tab 520 can extend circumferentially about the inner cover surface 516. In some aspects, the outer and inner snap tabs 518,520 can be formed as dovetail tabs. The outer and inner snap tabs 518,520 of the groove cover 154,156 can be configured to snap into, frictionally engage, or otherwise engage the outer and inner snap notches 312,314 (shown in FIG. 3), respectively, of the corresponding the circumferential groove 305 (shown in FIG. 3) to cover and protect the corresponding reinforcement ring 410 (shown in FIG. 4).

FIG. 6 illustrates a perspective view of one of the pipe engagement strips 162 (e.g., the first pipe engagement strip 162a or the second pipe engagement strip 162b, which can be substantially the same). Example aspects of the pipe engagement strip 162 can generally arcuate, which can be contoured to match the arc of the annular repair stent 105 (shown in FIG. 1). The arcuate pipe engagement strip 162 can define a substantially rectangular shape (i.e., having a length that is longer than a width) in the present aspect; however, in other aspects, the pipe engagement strip 162 can define any other suitable shape. As previously described, the pipe engagement strip 162 can be formed from a flexible, uncured epoxy or glue material which can harden into the arcuate shape shown once cured. Alternative, the pipe engagement strip 162 can be formed from a putty material or any other suitable material. The arcuate pipe engagement strip 162 can define an inner strip surface 610 that can face towards and be coupled to the outer stent surface 106 (shown in FIG. 1) of the repair stent 105 (shown in FIG. 1), and an outer strip surface 612 that can face away from the outer stent surface 106. The outer strip surface 612 can engage the inner wall of the pipeline in the expanded configuration of the repair stent 105. In some aspects, the outer strip surface 612 can be substantially smooth, while in other aspects, the outer strip surface 612 can be textured.

FIG. 7 illustrates a top view of the repair stent 105, and FIG. 8 shows a detailed cross- sectional view of the repair stent 105 taken along line 8-8 in FIG. 7. Referring to FIG. 7, the first groove cover 154 can be arranged proximate to the first gasket end 122 axially between the first sealing lip 320 of the gasket 120 and the textured portion 308 of the gasket 120, and the second groove cover 156 can be arranged proximate to the second gasket end 124 axially between the second sealing lip 322 and the textured portion 308 of the gasket 120. The outer cover surface 158 of each of the first and second groove covers 154,156 and the outer gasket surface 126 of the gasket 120 can define the outer stent surface 106. In some aspects, as shown, the outer cover surface 158 of each of the first and second groove covers 154,156 can extend slightly radially outward beyond the outer gasket surface 126, such that the width W/diameter D of the repair stent 105 at the outer cover surface 158 of each of the first and second groove covers 154,156 can be slightly greater that than the width W/diameter D of the repair stent 105 at the outer gasket surface 126 of the gasket 120.

According to example aspects, the friction elements 160 (e.g., the first and second pipe engagement strips 162a,b) can be applied or coupled to the outer stent surface 106 of the repair stent 105. Specifically, in the present aspect, the first and second pipe engagement strips 162a,b can be applied to the outer cover surface 158 of the first and second groove covers 154,156 proximate to the first and second gasket ends 122,124, respectively. Both of the first and second pipe engagement strips 162a,b can be positioned on the first gasket side 148 of the gasket 120. In the present aspect, the first pipe engagement strip 162a strip can be axially aligned with the second pipe engagement strip 162b, relative to the stent axis 110. In other aspects, the friction elements 160 can be arranged at any other suitable location on the outer stent surface 106.

Referring now to FIG. 8, the cross-sectional view illustrates the first reinforcement ring 410a and the first groove cover 154 arranged within the first circumferential groove 305a, and the first friction element 160a (e.g., the first pipe engagement strip 162a strip) applied to the first groove cover 154. The first circumferential groove 305a defines the outer snap notch 312, the inner snap notch 314, and the central reinforcement notch 310 therebetween. The first reinforcement ring 410a can be disposed within the central reinforcement notch 310, as shown. In the present aspects, each of the central reinforcement notch 310 and the first reinforcement ring 410a can define a cross-sectional shape of an inverted isosceles trapezoid.

The first groove cover 154 can overlay the first reinforcement ring 410a. The outer snap tab 518 of the first groove cover 154 can engage the outer snap notch 312 of the first circumferential groove 305a, and the inner snap tab 520 of the first groove cover 154 can engage the inner snap notch 314 of the first circumferential groove 305a, which can retain the first groove cover 154 on the gasket 120. In some aspects, the outer and inner snap notches 312,314 and the outer and inner snap tabs 518,520 can define the isosceles trapezoid cross-sectional shape to allow for dovetail connection therebetween. In other aspects, the outer and inner snap notches 312,314 and the outer and inner snap tabs 518,520 may not define the dovetail shape, and can define simple rectangular or square shapes, or any other suitable shapes. In some aspects, the outer and inner snap tabs 518,520 can be retained in the outer and inner snap notches 312,314, respectively, via friction, and/or the first groove cover 154 can be glued or otherwise coupled to the gasket 120 by any suitable fastener or fastening technique.

Furthermore, as shown, the first pipe engagement strip 162a can be applied to the outer stent surface 106 of the repair stent 105, and more specifically, can be applied to the outer cover surface 158 of the first groove cover 154 in the present aspect. A thickness T of the first pipe engagement strip 162a strip can be such that the first pipe engagement strip 162a strip can extend radially outward beyond the outer stent surface 106 of the repair stent 105. Thus, the width W and/or diameter D (shown in FIG. 1) of the repair stent 105 at the location of the first pipe engagement strip 162a strip can be greater the width W and/or diameter D at the outer stent surface 106 of the repair stent 105. In the expanded configuration of the repair stent 105, the pipe engagement strips 162 (or other friction elements 160) can be pressed against the inner wall of the pipeline to increase the friction between the repair stent 105 and inner wall and improve the grip of the repair stent 105 on the inner wall.

Also illustrated in FIG. 8 is the first tapered end portion 132 of the gasket 120 that can be defined at the first gasket end 122. As shown, the gasket 120 can taper radially inward at the first gasket end 122 generally from the outer gasket surface 126 to the inner gasket surface 128 to define the first tapered end portion 132. Similarly, the second tapered end portion 134 (shown in FIG. 1) can be defined at the second gasket end 124 (shown in FIG. 1). The first tapered end portion 132 and the second tapered end portion 134 can guide the fluid in the pipeline through the main passage 130 of the repair stent 105 to reduce the likelihood of fluid creeping in between the gasket 120 and the inner wall and dislodging the repair stent 105 from the desired location.

FIGS. 9 and 10 illustrate the repair stent 105 according to another example aspect of the disclosure. The repair stent 105 is shown in the collapsed (e.g., folded) configuration for transport through the pipeline. In the present aspect, the outer stent surface 106 of the repair stent 105 can be substantially smooth. The friction elements 160 (e.g., the first and second pipe engagement strips 162a,b) can be applied to the outer stent surface 106. According to example aspects, the first pipe engagement strip 162a strip can be arranged proximate to the first gasket end 122 of the gasket 120, and the second pipe engagement strip 162b can be arranged proximate to the second gasket end 124 of the gasket 120. The first and second pipe engagement strips 162a,b can be axially aligned at the first gasket side 146 of the gasket 120, opposite the second gasket side 148. An semispherical indentation is illustrated at the second gasket side 148; however, other aspects of the repair stent 105 may not comprise the indentation.

A force (e.g., a pushing or pulling force) can be applied to the repair stent 105 to fold or otherwise configure the repair stent 105 in the collapsed configuration. In the present aspect, the first gasket side 146 can be pushed radially inward, relative to the stent axis 110 (shown in FIG. 1), towards the opposite second gasket side 148 to fold the repair stent 105 into a C-shape, as shown. The first and second pipe engagement strips 162a,b arranged at the first gasket side 146 can be disposed within the interior fold 910 of the C-shaped repair stent 105 in the collapsed configuration. The positioning of the first and second pipe engagement strips 162a,b within the interior fold 910 can prevent the first and second pipe engagement strips 162a,b from catching on the inner wall of the pipeline as the repair stent 105 is transported through the pipeline. In other aspects, however, the first and second pipe engagement strips 162a,b may not be disposed within the interior fold 910 in the collapsed configuration, or the first and second pipe engagement strips 162a,b may be only partially disposed within the interior fold 910 in the collapsed configuration. For example, in other aspects, the first and second pipe engagement strips 162a,b can be formed as annular pipe engagement strips 162 extending fully about the circumference of the repair stent 105. In such an aspect, only a portion of each of the first and second pipe engagement strips 162a,b can be disposed within the interior fold 910.

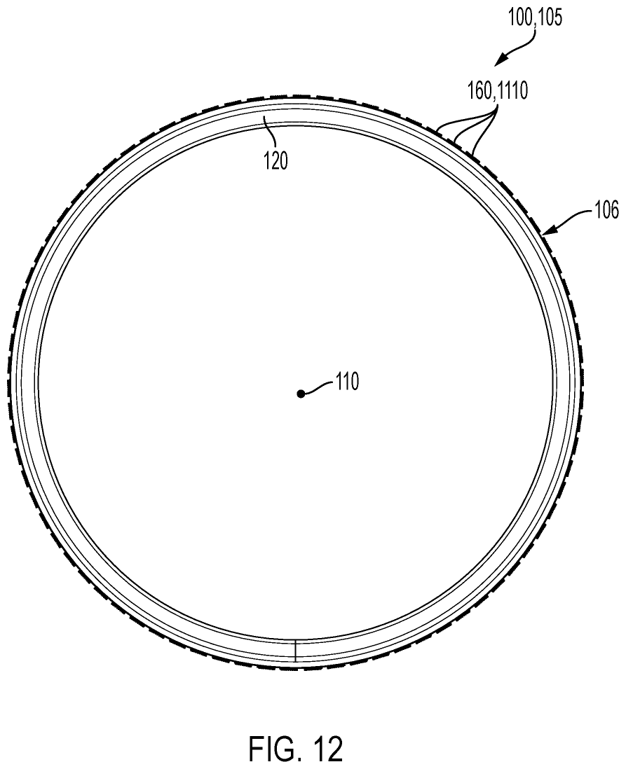

FIGS. 11 and 12 illustrate a perspective view and an end view, respectively, of the repair stent 105 in accordance with another aspect of the present disclosure. The repair stent 105 of the present aspect can comprise the gasket 120 and the structural chassis 150. The gasket 120 can be substantially cylindrical in the expanded configuration and can be formed as a continuous, tubular sleeve structure. The gasket 120 can define the first gasket end 122 and the second gasket end 124, and can further define the outer gasket surface 126 and the inner gasket surface 128. The inner gasket surface 128 can define the main passage 130 therethrough. The stent axis 110 of the repair stent 105 can extend centrally through the main passage 130 from the first gasket end 122 to the second gasket end 124. Example aspects of the gasket 120 can also define the first tapered end portion 132 and the second tapered end portion 134, which can help guide fluid in the pipeline through the main passage 130 and reduce the likelihood of fluid creeping in between the gasket 120 and the inner wall of the pipeline. As previously described, in some example aspects, a plurality of the repair stents 105 can be joined together in series in the axial direction, relative to the stent axis 110, to form a lengthened repair stent 105 for repairing larger cracks or damage in the pipeline.

In the present aspect, the outer gasket surface 126 or portions thereof can be textured. The textured outer gasket surface 126 can improve the grip of the outer gasket surface 126 on the inner wall of the pipeline. For example, as previously described, the outer gasket surface 126 can define a plurality of the raised ridges 136 extending radially outward relative to the stent axis 110 and a plurality of the recessed dimples 140 formed between and disposed radially inward of the raised ridges 136, relative to the stent axis 110. In some aspects, the raised ridges 136 can be arranged in a crisscross or waffle pattern, as shown, or can be arranged to define any other suitable pattern. Each of the raised ridges 136 can be curved or chamfered at the radially outer end 138 thereof. In other aspects, the outer gasket surface 126 may not comprise the raised ridges 136 as described, but can be otherwise textured, uneven, bumpy, rough, or non-smooth. In other aspects, the outer gasket surface 126 can be substantially smooth.

The outer gasket surface 126 of the gasket 120 can further define the first circumferential groove 305a (shown in FIG. 3) formed proximate to the first gasket end 122 and the second circumferential groove 305b (shown in FIG. 3) formed proximate to the second gasket end 124. The first reinforcement ring 410a (shown in FIG. 4) can be disposed within the first circumferential groove 305a and the second reinforcement ring 410b (shown in FIG. 4) can be disposed within the second circumferential groove 305b. The annular first groove cover 154 can cover the first circumferential groove 305a and the first reinforcement ring 410a at the first gasket end 122. The annular second groove cover 156 can cover the second circumferential groove 305b and the second reinforcement ring 410b at the second gasket end 124. In the present aspect, the outer cover surface 158 of each of the first and second groove covers 154,156 can be substantially smooth.

Example aspects of the repair stent 105 can further comprise one or more of the friction elements 160 extending from the outer stent surface 106 of the repair stent 105. The friction elements 160 can be configured to engage the inner wall of the pipeline in the expanded configuration to further improve the grip of the repair stent 105 on the inner wall of the pipeline. In the present aspect, the friction elements 160 can comprise a plurality of grippers 1110. Each of the grippers 1110 can comprise one or more teeth 1116 extending radially outward from the repair stent 105 and configured to dig into the inner wall of the pipeline in the expanded configuration. According to example aspects, a first set 1112 of the plurality of grippers 1110 can be spaced circumferentially about the repair stent 105 proximate to the first gasket end 122, and a second set 1114 of the plurality of grippers 1110 can be spaced circumferentially about the repair stent 105 proximate to the second gasket end 124. The first set 1112 of the grippers 1110 can be coupled to the outer cover surface 158 of the first groove cover 154, and the second set 1114 of the grippers 1110 can be coupled to the over cover surface 158 of the second groove cover 156. In other aspects, the grippers 1110 can be arranged at any suitable location on the outer stent surface 106, including on the outer gasket surface 126 of the gasket 120. Other aspects of the repair stent 105 can comprise more or fewer grippers 1110.

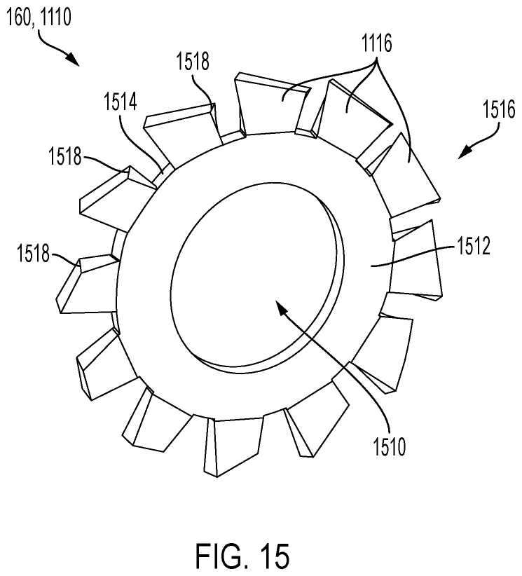

In example aspects, a plurality of mounting studs 1120 can extend radially outward from the outer cover surface 158 of each of the first and second groove covers 154, 156. Each of the mounting studs 1120 can be substantially circular in shape in the present aspect. Each of the grippers 1110 can define a substantially circular stud opening 1510 (shown in FIG. 15) that can be configured to receive a corresponding one of the mounting studs 1120 therethrough to mount the gripper 1110 on the mounting stud 1120. As previously described, in example aspects, the first and second groove covers 154,156 can comprise a resilient, flexible metal material, such as rubber, for example and without limitation. The flexible, resilient material of the first and second groove covers 154,156 can allow each of the mounting studs 1120 to be compressed and pushed into the stud opening 1510 of the corresponding gripper 1110. Friction between the compressed mounting stud 1120 and the gripper 1110 can hold the gripper 1110 in place on the mounting stud 1120. In some aspects, the grippers 1110 can further be secured to the repair stent 105 by glue or any other suitable fastener or fastening technique known in the art.

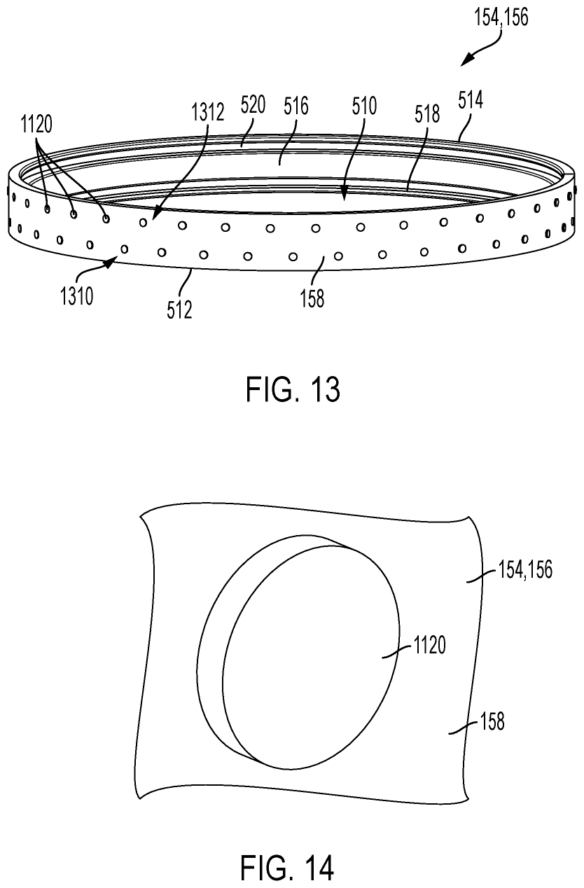

FIG. 13 illustrates a perspective view of one of the groove covers 154,156 (e.g., the first groove cover 154 or the second groove cover 156, which can be substantially the same). The groove cover 154,156 can be substantially annular, as shown, and can define the cover opening 510 through the center thereof. The groove cover 154,156 can define the first cover end 512, the second cover end 514 opposite the first cover end 512, the outer cover surface 158, and the inner cover surface 516 opposite the outer cover surface 158. The groove cover 154,156 can define the outer snap tab 518 extending radially inward from the inner cover surface 516 at the first cover end 512 and the inner snap tab 520 extending radially inward from the inner cover surface 516 at the second cover end 514, relative to the stent axis 110 (shown in FIG. 1). Each of the outer snap tab 518 and the inner snap tab 520 can extend circumferentially about the inner cover surface 516. In some aspects, the outer and inner snap tabs 518,520 can be formed as dovetail tabs. The outer and inner snap tabs 518,520 of the groove cover 154,156 can be configured to snap into the outer and inner snap notches 312,314 (shown in FIG. 3), respectively, of the corresponding the circumferential groove 305 (shown in FIG. 3).

The outer cover surface 158 can be substantially smooth in the present aspect, and a plurality of the mounting studs 1120 can extend radially outward from the substantially smooth outer cover surface 158. In the present aspect, the plurality of mounting studs 1120 can be arranged in a first annular row 1310 proximate to the first cover end 512 and a second annular row 1312 proximate to the second cover end 514. FIG. 14 illustrates a detail view of one of the substantially circular mounting studs 1120 extending from the outer cover surface 158 of the groove cover 154,156. In other aspects, the mounting stud 1120 can define any other suitable shape corresponding to the shape of the stud opening 1510 (shown in FIG. 15) of the gripper 1110 (shown in FIG. 11).

FIG. 15 illustrates an example aspect of the friction element 160, which can be the gripper 1110 in the present aspect. As shown, the gripper 1110 can define a gripper base 1512, and the substantially circular stud opening 1510 can be defined through the gripper base 1512. The stud opening 1510 can receive a corresponding one of the mounting studs 1120 (shown in FIG. 11), and the gripper base 1512 can confront the outer cover surface 158 (shown in FIG. 11) of the corresponding groove cover 154,156 (shown in FIG. 11). According to example aspects, a plurality of the teeth 1116 can be configured to dig into the inner wall of the pipeline. Each of the teeth 1116 can generally extend radially outward and forward from an outer base edge 1514 of the gripper base 1512, relative to the orientation shown. In the present aspect, the gripper 1110 can be formed as an external tooth lock washer 1516, wherein each of the teeth can be twisted relative to the gripper base 1512 to angle a pointed tip 1518 of the tooth 1116 in a forward direction (i.e., coming out of the page), relative to the orientation shown. When the gripper 1110 is assembled with the repair sent 105 (shown in FIG. 11), the teeth 1116 can be angled radially outward relative to the stent axis 110 (shown in FIG. 1) to engage the pointed tip 1518 of each tooth 1116 with the inner wall of the pipeline. In other aspects, the grippers 1110 can comprise any suitable friction element 160 having teeth, points, sharp edges, and/or texture that can be installed on the mounting studs 1120 (shown in FIG. 11) and which can improve the grip of the repair stent 105 (shown in FIG. 1) on the inner wall of the pipeline.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A pipe repair stent comprising:
a gasket defining a first gasket end, a second gasket end opposite the first gasket end, an outer gasket surface, and an inner gasket surface opposite the outer gasket surface, the inner gasket surface defining a main passage, a stent axis extending centrally through the main passage, the outer gasket surface at least partially defining an outer stent surface of the pipe repair stent; and
a first pipe engagement strip coupled to and extending circumferentially along the outer stent surface proximate to the first gasket end; and
a second pipe engagement strip coupled to and extending circumferentially along the outer stent surface proximate to the second gasket end;
wherein each of the first and second pipe engagement strips extend radially outward beyond the outer stent surface and are configured to engage an inner wall of a pipe to improve a grip of the pipe repair stent on the inner wall.

2. The pipe repair stent of claim 1, wherein:
the gasket defines a first gasket side and a second gasket side opposite the first gasket side; and
the first pipe engagement strip is axially aligned with the second pipe engagement strip at the first gasket side.

3. The pipe repair stent of claim 2, wherein:
the pipe repair stent is configurable in an expanded configuration and a collapsible configuration;
the pipe repair stent defines a substantially cylindrical sleeve in the expanded configuration; and
in the collapsed configuration, each of the first and second pipe engagements strip is disposed within an interior fold of the pipe repair stent.

4. The pipe repair stent of claim 3, wherein, the first gasket side is pushed radially inward towards the second gasket side in the collapsed configuration to fold the pipe repair stent into a C-shape.

5. The pipe repair stent of claim 3, wherein:
each of the first and second pipe engagement strips comprises an epoxy material;
the epoxy material is uncured and flexible in the collapsed configuration; and
the epoxy material cures and hardens in the expanded configuration.

6. The pipe repair stent of claim 1, wherein:
the outer gasket surface defining a first circumferential groove oriented proximate to the first gasket end and a second circumferential groove oriented proximate to the second gasket end; and
the pipe repair stent further comprises a structural chassis comprising a first reinforcement ring disposed in the first circumferential groove and a second reinforcement ring disposed in the second circumferential groove.

7. The pipe repair stent of claim 6, wherein the outer gasket surface defines a textured portion comprising a plurality of raised ridges and recessed dimples, the textured portion of the outer gasket surface disposed axially between the first circumferential groove and the second circumferential groove.

8. The pipe repair stent of claim 6, wherein:
the structural chassis further comprises a first groove cover disposed radially outward of and covering the first reinforcement ring and a second groove cover disposed radially outward of and covering the second reinforcement ring;
each of the first and second groove cover defines an outer cover surface at least partially defining the outer stent surface of the pipe repair stent and an inner cover surface opposite the outer cover surface;
the first pipe engagement strip is coupled to the outer cover surface of the first groove cover; and
the second pipe engagement strip is coupled to the outer cover surface of the second groove cover.

9. The pipe repair stent of claim 8, wherein:
each of the first and second circumferential grooves defines a central reinforcement notch and a first snap notch;
the first reinforcement ring is received in the central reinforcement notch of the first circumferential groove, and the second reinforcement ring is received in the central reinforcement notch of the second circumferential groove;
each of the first groove cover and the second groove cover defines a first snap tab extending radially inward from the inner cover surface; and
the first snap tab of the first groove cover is snapped into the first snap notch of the first circumferential groove, and the first snap tab of the second groove cover is snapped into the first snap notch of the second circumferential groove.

10. A pipe repair stent comprising:
a gasket defining a first gasket end, a second gasket end opposite the first gasket end, an outer gasket surface, and an inner gasket surface opposite the outer gasket surface, the inner gasket surface defining a main passage, a stent axis extending centrally through the main passage, the outer gasket surface at least partially defining an outer stent surface of the pipe repair stent; and
a first plurality of grippers coupled to and extending radially outward from the outer stent surface proximate to the first gasket end; and
a second plurality of grippers coupled to and extending radially outward from the outer stent surface proximate to the second gasket end;
wherein each of the first plurality of grippers and the second plurality of grippers are configured to engage an inner wall of a pipe to improve a grip of the pipe repair stent on the inner wall.

11. The pipe repair stent of claim 10, wherein:
a first plurality of mounting studs extends radially outward from the outer stent surface proximate to the first gasket end and a second plurality of mounting studs extends radially outward from the outer stent surface proximate to the second gasket end;
each gripper of the first plurality of grippers is mounted to one of the mounting studs of the first plurality of mounting studs; and
each gripper of the second plurality of grippers is mounted to one of the mounting studs of the second plurality of mounting studs.

12. The pipe repair stent of claim 11, wherein the first plurality of mounting studs are spaced circumferentially about the pipe repair stent at the first gasket end and the second plurality of mounting studs are spaced circumferentially about the pipe repair stent at the second gasket end.

13. The pipe repair stent of claim 11, wherein each gripper of the first plurality of grippers and the second plurality of grippers comprises:
a gripper base defining a stud opening configured to receive one of the mounting studs of the first plurality of mounting studs and the second plurality of mounting studs; and
a plurality of teeth extending radially outward from the gripper base and configured to engage the inner wall of the pipe to improve a grip of the pipe repair stent on the inner wall.

14. The pipe repair stent of claim 11, wherein:
the gasket defines a first gasket side and a second gasket side opposite the first gasket side;
the pipe repair stent is configurable in an expanded configuration and a collapsible configuration;
the pipe repair stent defines a substantially cylindrical sleeve in the expanded configuration; and
in the collapsed configuration, the first gasket side is pushed radially inward towards the second gasket side to fold the pipe repair stent into a C-shape.

15. The pipe repair stent of claim 14, wherein:
the outer gasket surface defining a first circumferential groove oriented proximate to the first gasket end and a second circumferential groove oriented proximate to the second gasket end; and
the pipe repair stent further comprises a structural chassis comprising a first reinforcement ring disposed in the first circumferential groove and a second reinforcement ring disposed in the second circumferential groove.

16. The pipe repair stent of claim 15, wherein the outer gasket surface defines a textured portion comprising a plurality of raised ridges and recessed dimples, the textured portion of the outer gasket surface disposed axially between the first circumferential groove and the second circumferential groove.

17. The pipe repair stent of claim 15, wherein:
the structural chassis further comprises a first groove cover disposed radially outward of and covering the first reinforcement ring and a second groove cover disposed radially outward of and covering the second reinforcement ring;
each of the first and second groove cover defines an outer cover surface at least partially defining the outer stent surface of the pipe repair stent and an inner cover surface opposite the outer cover surface;
the first plurality of mounting studs extend from the outer cover surface of the first groove cover; and
the second plurality of mounting studs extend from the outer cover surface of the second groove cover.

18. The pipe repair stent of claim 17, wherein:
each of the first and second circumferential grooves defines a central reinforcement notch and a first snap notch;
the first reinforcement ring is received in the central reinforcement notch of the first circumferential groove, and the second reinforcement ring is received in the central reinforcement notch of the second circumferential groove;
each of the first groove cover and the second groove cover defines a first snap tab extending radially inward from the inner cover surface; and
the first snap tab of the first groove cover is snapped into the first snap notch of the first circumferential groove, and the first snap tab of the second groove cover is snapped into the first snap notch of the second circumferential groove.

19. A method of repairing a pipeline comprising:
providing a pipe repair stent, the pipe repair stent comprising a gasket, a first friction element, and a second friction element, the gasket defining a first gasket end, a second gasket end, an outer gasket surface, and an inner gasket surface, the outer gasket surface at least partially defining an outer stent surface of the pipe repair stent, the first friction element coupled to the outer stent surface proximate to the first gasket end and the second friction element coupled to the outer stent surface proximate to the second gasket end;
transporting the pipe repair stent through the pipeline in a collapsed configuration to a location of damage;
expanding the pipe repair stent to an expanded configuration to seal the outer gasket surface with an inner wall of the pipeline; and
pressing the first friction element and the second friction element between the outer stent surface and the inner wall of the pipeline to increase friction between the pipe repair stent and the inner wall.

20. The method of claim 19, wherein:
the first friction element is a first pipe engagement strip coupled to and extending circumferentially along the outer stent surface proximate to the first gasket end;
the second friction element is a second pipe engagement strip coupled to and extending circumferentially along the outer stent surface proximate to the second gasket end;
each of the first and second pipe engagement strips comprises a flexible, uncured epoxy material; and
the method further comprises curing the epoxy material of the first and second pipe engagement strips after the pipe repair stent is expanded to the expanded configuration to harden the first and second pipe engagement strips.

21. The method of claim 19, wherein:
the first friction element is a first gripper and the second friction element is a second gripper;
the first gripper is mounted to a first mounting stud extending radially outward from the outer stent surface proximate to the first gasket end;
the second gripper is mounted to a second mounting stud extending radially outward from the outer stent surface proximate to the second gasket end; and
each of the first gripper and the second gripper comprises a plurality of teeth extending radially outward from the outer stent surface.
